(19) United States
(12) Patent Application Publication
(10) Pub. No.: US 2002/0128006 A1
(43) Pub. Date: Sep. 12, 2002

(54) Radio frequency (RF) detector with a light emitting diode (LED) indicator

(76) Inventors: Joseph W. Martine, Lawrenceville, GA (US); David W. Wallis, Atlanta, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/802,212

(22) Filed: Mar. 8, 2001

(51) Int. Cl. H04Q 7/20

(52) U.S. Cl. 455/423; 455/115

(57) ABSTRACT

A broadband communications system for providing radio frequency (RF) signals to subscriber equipment that includes an amplifier for amplifying the RF signals and for providing an indication of the presence of the RF signals. The amplifier includes an input for receiving the RF signals, a first gain circuit for amplifying the RF signals and providing amplified RF signals, and an output for providing the amplified RF signals to the subscriber equipment. An RF detector included within the amplifier where there is a tap circuit for diverting a portion of the amplified RF signals, the tap circuit connected between the first gain circuit and the output, a gain circuit for amplifying the diverted RF signals, a rectification circuit for converting the amplified diverted RF signal to a DC voltage, a comparator for comparing the DC voltage to a reference voltage, and an indicator connected to the comparator for indicating when the DC voltage exceeds the reference voltage, whereby the DC voltage exceeding the reference voltage indicates the presence of an RF signal.

### FIELD OF THE INVENTION

This invention relates generally to broadband communications systems, such as cable television systems, and the electronic devices used in such systems, and more specifically, to drop amplifiers with RF signal detection devices.

### BACKGROUND OF THE INVENTION

A communication system 100, such as a two-way cable television system, is depicted in FIG. 1. The communication system 100 includes headend equipment 105 for generating forward signals that are transmitted in the forward, or downstream, direction along a communication medium, such as a fiber optic cable 110, to an optical node 115 that converts optical signals to radio frequency (RF) signals. The RF signals are further transmitted along another communication medium, such as coaxial cable 120, and are amplified, as necessary, by one or more distribution amplifiers 125 positioned along the communication medium. Taps 130 included in the cable television system 100 split off portions of the forward signals for provision to subscriber equipment 135, such as set top terminals, computers, and televisions.

The system 100 also has reverse transmission capability so that signals, such as data, video, or data signals, generated by the subscriber equipment 135 can be provided back to the headend 105 for processing. The reverse signals travel through the taps 130 and any nodes 115 and other cable television equipment, e.g., reverse amplifiers, to the headend 105. In the configuration shown in FIG. 1, RF signals generated by the subscriber equipment 135 travel to the node 115, which converts the RF signals to optical signals for transmission over the fiber optic cable 110 to the headend 105.

FIG. 2 illustrates a subscriber 205 that is receiving RF signals through the tap 130. At times, it is necessary to include a drop amplifier 210 within close proximity to the subscriber 205. The drop amplifier 210 is shown mounted on the outside of the subscriber's home; however, alternatively, it can be mounted within the home. As data, advanced video, and voice services are made available over broadband systems, the demand for signal level at the subscriber's premises increases. Typically, this increased demand is distributed over various customer segments and is not universal; therefore, deployment of the drop amplifier 210 is the most cost-effective solution for the cable television operator.

The absence or insufficiency of the RF signal may be caused by cable that is cut in the field or within a home, or may be due to inherent cable losses, the transmitted RF signal being too low, thereby causing reception problems or no reception at all. The cable company often sends technicians out in the field to investigate and solve these reception problems. Ultimately, much effort is undertaken in order to determine whether the subscriber is receiving adequate RF signals. Thus, what is needed is a convenient device that allows a subscriber to easily determine if they are not receiving RF signals and inform the cable company.

### BRIEF DESCRIPTION OF THE DRAWINGS

FIG. 1 depicts a communications system, such as a cable television system.

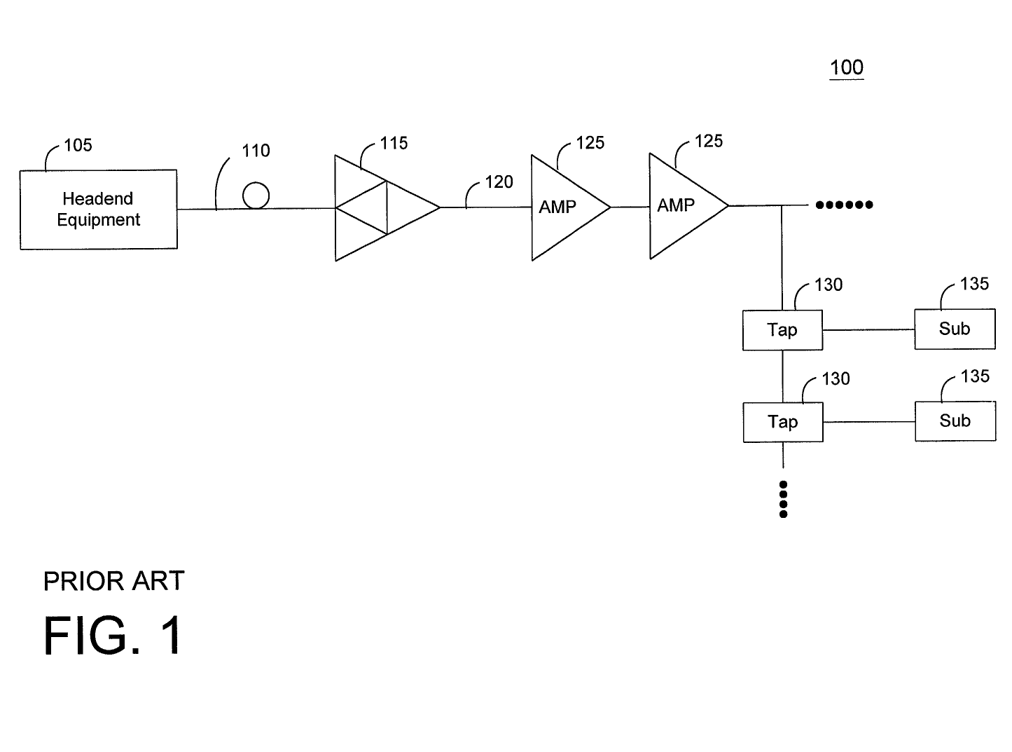

FIG. 2 illustrates a subscriber receiving RF signals through a distribution tap within the system of FIG. 1.

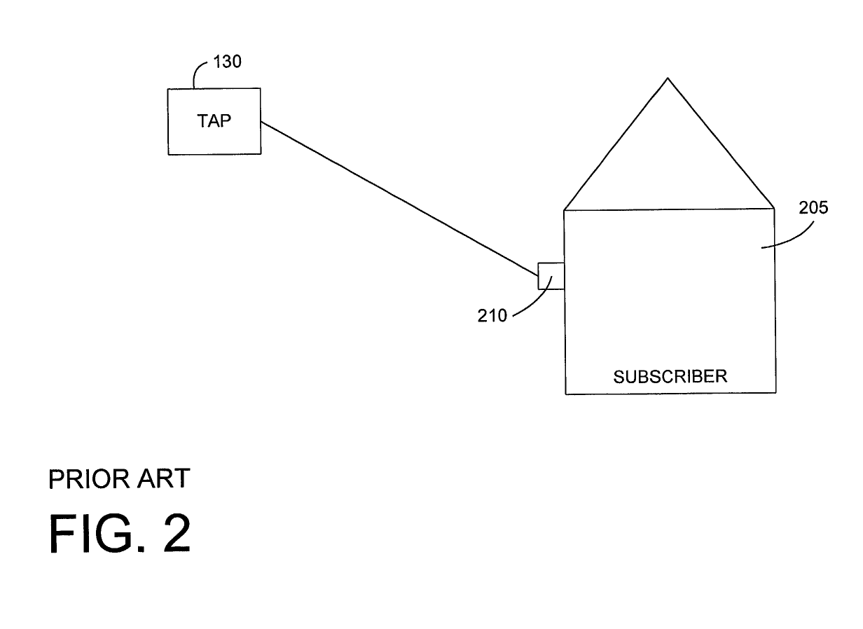

FIG. 3 illustrates a drop amplifier in accordance with the present invention.

FIG. 4 illustrates a block diagram of the indicator circuitry of FIG. 3.

FIG. 5 illustrates a schematic of the block diagram of FIG. 4.

### DETAILED DESCRIPTION OF A PREFERRED EMBODIMENT

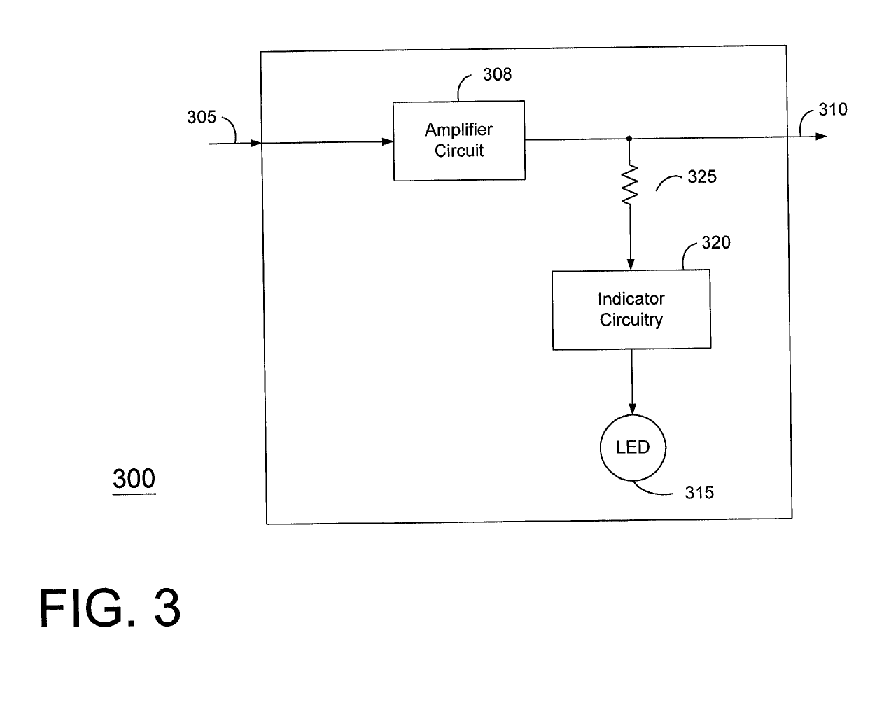

In accordance with the present invention, FIG. 3 illustrates a drop amplifier that includes an RF detector for providing a visual indication that RF signals are present within the drop amplifier 300, which supplies an amplified RF signal to the subscriber. U.S. Pat. No. 6,161,011 to Loveless, the teachings of which are incorporated herein by reference, shows a hybrid fiber coax communications system in which one could implement the drop amplifier 300 and RF detector of the present invention.

The drop amplifier 300 is generally installed on the outside of a subscriber's home, or alternatively, placed within the home. An input port 305 receives the RF signals from a distribution tap installed within the broadband communications system. Amplification circuitry 308 then boosts the RF signals sufficiently enough for the requirements of the subscriber. Typically, the drop amplifier 300 will amplify the RF signals by seven to fifteen decibels (dBs). The amplification within the drop amplifier 300 replaces the need to install an RF amplifier somewhere along the communications path, thereby saving much time and installation costs as well as the material costs. An output port 310 then provides the amplified RF signals to the subscriber equipment, such as a digital home communications terminal (DHCT) or directly to a television.

Also included within the drop amplifier 300 is an exposed light emitting diode (LED) 315. The LED 315 provides a simple indication of whether RF signals are present within the drop amplifier 300 or not. As briefly mentioned in the Background of the Invention, at times RF signals are either too low or not present within the drop amplifier 300, and this prevents quality pictures being shown on the television. The LED 315 saves much time and effort on the part of the cable operator and allows the cable operator to know immediately that the problem is the lack of a sufficient RF signal within that particular subscriber's home. An indicator circuit 320 controls the LED 315.

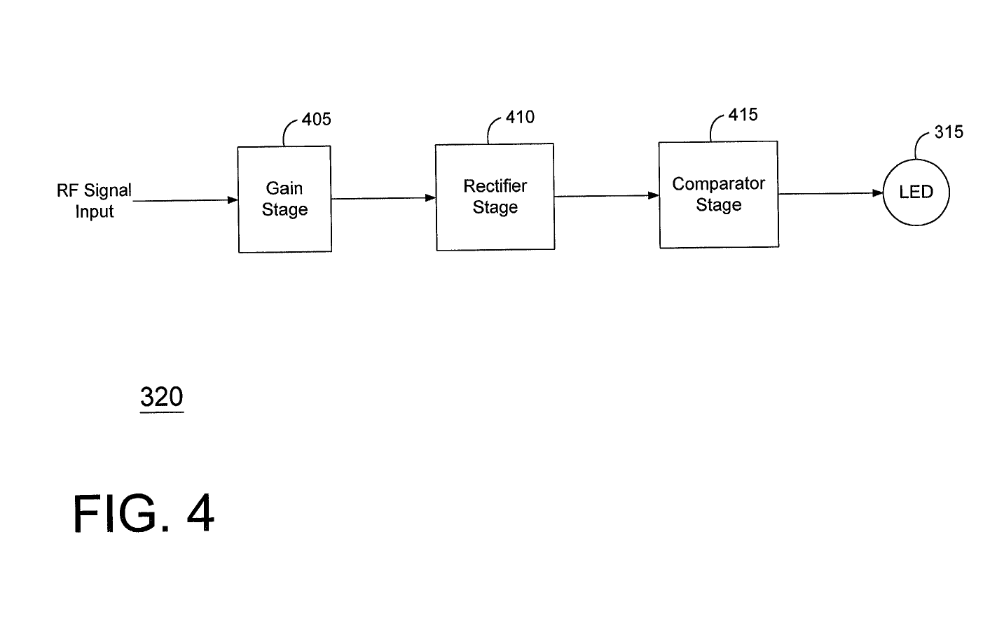

FIG. 4 is a block diagram depicting the internal circuitry associated with the indicator circuit 320 (FIG. 3). Briefly, a portion of the RF signal within the drop amplifier 300 is provided to the indicator circuit 320 via a large value resistor 325 (FIG. 3), for example, 1 kilo ohm, that is coupled to the main output RF circuit path after the drop amplifier's amplifier circuit 308. The resistor value can be changed to a different high impedance value depending upon the insertion loss of the drop amplifier 300. In this manner, the indicator circuit 320 will benefit from the amplification that was previously performed within the amplifier circuit 308. This portion of the RF signal is then provided to a gain stage 405 for necessary amplification within the indicator circuit 320. A rectifier stage 410 converts the amplified RF signals to a DC voltage that is provided to a comparator stage 415. The comparator stage 415 then compares the DC voltage to a fixed reference voltage. The reference voltage can be equal to ground, which is typically zero, or it can be equal to the noise floor. Typically, the noise floor in the cable television system is −60 dB or more above ground.

The output of the comparator stage 415 is provided to the LED 315. The LED 315 illuminates if the received DC voltage exceeds ground, or the noise floor, thereby indicating the drop amplifier 300 is receiving adequate RF signal levels. If there is no difference, the LED 315 is not illuminated indicating that there are either no RF signals or the RF signals are too low to output quality pictures.

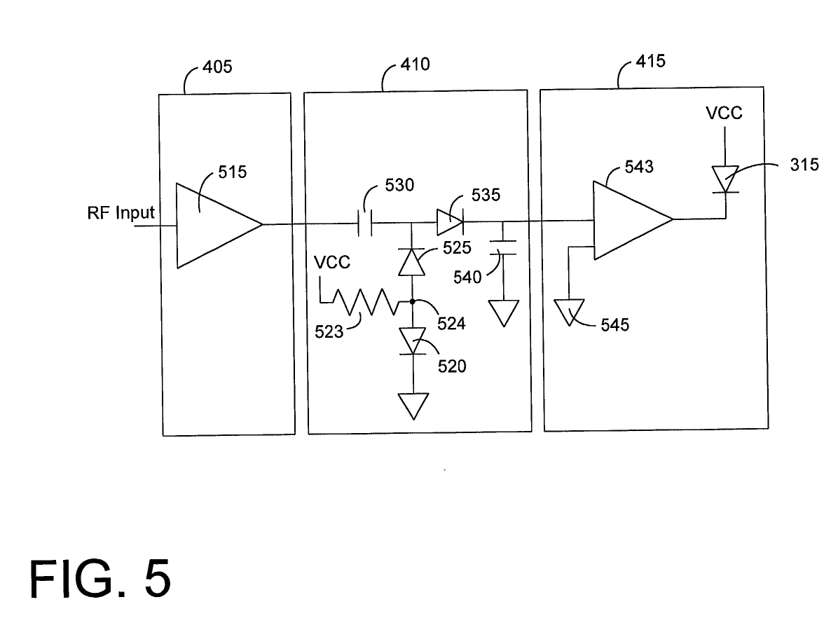

FIG. 5 is a schematic of the block diagram depicting the indicator circuitry 320 shown in FIG. 4. In the gain stage 405, a conventional bipolar transistor 515 is used to amplify the received low level RF signal. It will be appreciated that one transistor 515 is shown; however, two or three transistors may be required if further amplification is needed. The bipolar transistor 515 is a very inexpensive, off-the-shelf component. The amplified RF signal is then provided to the rectifier stage 410.

The rectifier stage 410 is a full wave rectifier that includes three diodes and two capacitors. The rectifier stage 410 converts the RF signal to a DC voltage for comparison in the comparator stage 415. Diode 520 is a bias diode that is also used as a temperature compensator. Diode 520 is always biased on by being coupled to a voltage reference, VCC, of the drop amplifier 300 via resistor 523. Additionally, diode 520 references junction 524 with a value greater than zero. Therefore, as diode 525 changes with temperature, diode 520 compensates for the temperature drift. More specifically, the bias diode 520 recaptures any voltage drops across diode 525 enabling the full wave rectification within the rectifier stage 410. Capacitor 530 and diodes 525, 535 are used to store the voltage and perform the rectification. Capacitor 540 stores and provides the DC voltage, which is indicative of the RF signal level, to the input of the comparator stage 415.

The comparator 543 compares the DC voltage to a fixed reference value. Shown as ground 545, the reference value can alternatively be a larger value to compensate for the noise floor that is present within a cable television system. The output of the comparator 543 is provided to LED 315. The LED 315 is also coupled to the voltage reference, VCC, for illuminating the LED 315. If an RF signal is present, the comparator 543 outputs a low signal that creates a voltage difference to turn on the LED 315. If there is no RF signal present, the comparator 543 outputs a high signal such that there is not a voltage difference and, therefore, the LED 315 does not illuminate.

The indicator circuit 320 has a frequency range from 5 Mega Hertz (MHz) to approximately 100 MHz. Typically, a cable television system transmits a forward bandwidth from 52 MHz to 860 MHz. The cable television channels that are used to detect the presence of an RF signal are National Television system Committee (NTSC) channels 2 through 6. Channels 2 through 6 are typically local network channels that re within the lower range of the overall bandwidth. Since the drop amplifier 300 is placed before the television within a subscriber's home, all broadcast channels within the bandwidth pass through the drop amplifier 300. The indicator circuit 320 is capable of detecting RF signal levels as low as 2 decibels per milli Volt (dBmV) for Channel 2, which is approximately 54 to 60 MHz, and capable of detecting RF signal levels as low as 14 dBmV for Channel 6, which is approximately 82 to 88 MHz.

Conventional methods of performing RF signal detection at low levels, such as 2 dBmV to 14 dBmV, is to place a coupler on the output RF circuit path within a drop amplifier and filter the signal to ensure an adequate signal appropriate with the RF signal detection circuit. The RF signal is amplified and then uses a window comparator to detect the RF signals. The problem with this method is the large amount of signal loss, typically 1 dB or more, induced by the coupler on the output RF circuit path, thereby causing the output of the drop amplifier to be 1 dB lower than after the amplification. Additionally, the number of components and the costs for these components are excessive in comparison to the drop amplifier's costs.

The advantages to the present invention are the low cost of the components and the low signal losses. By using the large value resistor 325 and diverting a portion of the RF signal only, the signal loss is only tenths of a dB induced onto the output RF circuit path. Return loss is also well within an acceptable limit for the application. The large value resistor 325 also equates to a small value RF signal that is used within the indicator circuit 320 to ensure an easy and cost-effective device 320 for use within the drop amplifier 300.

In summary, the indicator circuit 320 is a cost effective device that is easily included within the drop amplifier 300 without adding much time and effort. The subscriber can easily look at the indicator LED 315 to determine if an adequate RF signal level is being received.

What is claimed is:

1. An RF detector for detecting RF signals, comprising:
a gain circuit for amplifying the RF signals;
a rectification circuit for changing the RF signals to a DC voltage;
a comparator for comparing the DC voltage to a reference voltage; and
an LED coupled to the comparator for indicating that RF signals are present within the RF detector and for indicating that RF signals are not present within the RF detector, wherein RF signals are present when the comparator detects a difference between the DC voltage and the reference voltage

2. The RF detector of claim 1, wherein the rectification circuit is a full wave rectifier, comprising:
a biasing diode acting as a temperature compensator for compensating for drifts over temperature.

3. The RF detector of claim 1, wherein the reference voltage is equal to an averaged noise floor that may be present.

4. The RF detector of claim 1, wherein the reference voltage is equal to ground.

5. The RF detector of claim 1, wherein the bandwidth of the RF detector ranges from 5 MHz to approximately 100 MHz.

6. The RF detector of claim 5, wherein the RF signals are detected within channels that are included within the RF detector bandwidth.

7. The RF detector of claim 6, wherein the RF detector detects RF signal levels as low as 2 dBmV for channel 2 and 14 dBmV for channel 6, where each channel has a bandwidth of 6 MHz.

8. The RF detector of claim 1, wherein the RF detector is used within a drop amplifier.

9. The RF detector of claim 8, wherein the drop amplifier is used within a communications system.

10. A drop amplifier including an RF detector for providing a visual indication that RF signals are present within the drop amplifier, the drop amplifier comprising:
an input port for receiving RF signals from upstream;
an amplifier for amplifying the received RF signals;
a tap circuit for diverting a portion of the received RF signals;
an RF detector coupled to the tap circuit, the RF detector comprising:
a gain circuit for amplfying the RF signals;
a rectification circuit for changing the RF signals to a DC voltage;
a comparator for comparing the DC voltage to a reference voltage; and
an LED for indicating that RF signals are present within the drop amplifier,
wherein RF signals are present when the comparator detects a difference between the DC voltage and the reference voltage, and
an output port for providing the amplified RF signals to a subscriber,
whereby the LED of the RF detector provides a visual indication notifying the subscriber to the presence of RF signals through the drop amplifier.

11. The drop amplifier of claim 10, wherein the reference voltage is equal to an averaged noise floor that may be present.

12. The drop amplifier of claim 10, wherein the reference voltage is equal to ground.

13. The drop amplifier of claim 10, wherein the bandwidth of the RF detector ranges from 5 MHz to approximately 100 MHz.

14. The drop amplifier of claim 10, wherein the drop amplifier is used with a communications system.

15. The drop amplifier of claim 14, wherein the communications system transmit the RF signals through a hybrid fiber coaxial (HFC) cable network.

16. In a broadband communications system for providing radio frequency (RF) signals to subscriber equipment, an amplifier for amplifying said RF signals and for providing an indication of the presence of said RF signals, said amplifier comprising:
an input for receiving said RF signals,
a first gain circuit for amplifying said RF signals and providing amplified RF signals;
an output for providing said amplified RF signals to said subscriber equipment; and
an RF detector including
a tap circuit for diverting a portion of said amplified RF signals, said tap circuit connected between said first gain circuit and said output;
a gain circuit for amplifying said diverted RF signals;
a rectification circuit for converting said amplified diverted RF signal to a DC voltage;
a comparator for comparing said DC voltage to a reference voltage; and
an indicator connected to said comparator for indicating when said DC voltage exceeds said reference voltage,
whereby the DC voltage exceeding said reference voltage indicates the presence of an RF signal.

17. The broadband communications system of claim 16, wherein said tap circuit comprises a high impedance resistor, whereby the tap circuit induces little loss signal loss at the output of the amplifier.
